(19) United States
(12) Patent Application Publication
(10) Pub. No.: US 2018/0367982 A1
(43) Pub. Date: Dec. 20, 2018

(54) USER-CONTROLLED DISTRIBUTION AND COLLECTION OF TRACKED DATA

(71) Applicant: THOMSON Licensing, Issy-Les-Moulineaux (FR)

(72) Inventors: Joel M. FOGELSON, Pasadena, CA (US); Arden ASH, Los Angeles, CA (US)

(21) Appl. No.: 15/736,879

(22) PCT Filed: Jun. 16, 2016
(86) PCT No.: PCT/US2016/037741

§ 371 Date: Dec. 15, 2017

Related U.S. Application Data
(60) Provisional application No. 62/181,473, filed on Jun. 18, 2015.

(51) Int. Cl. H04W 8/16; G06Q 30/02

(52) U.S. Cl. CPC H04W 8/16; G06Q 30/0267; G06Q 30/0261

(57) ABSTRACT

Ways to control distribution and tracking of consumer information are described. Such tracking may be associated with user device (110) presence within a defined region (440). The user device provides at least one user interface (UI) (100) listing a set of information types to be tracked within the defined region. The UI includes a set of controllers (170) that are able to receive a set of user selections regarding distribution and tracking of the information types. The information types include location, identity recognition, and transaction information. Based on the set of user selections, collection and/or tracking of information may be performed (or not) depending on the states of each controller in the set of controllers.

### BACKGROUND

With the proliferation of mobile and wearable devices, tracking of people as they move from location to location is becoming ubiquitous. Such location tracking may be performed by remote device, such as through triangulation of a cell phone position by a service provider. In addition, many devices may determine location locally (e.g., using a global positioning system or GPS enabled device) and may provide such data to other elements.

In many cases, users may not be aware that information is being tracked. In addition, users may not be aware of the type(s) of information that is being recorded or analyzed by others.

### SUMMARY

Some embodiments provide ways to control information that is tracked by various venues. Tracked information may include location or position, transaction information, and identity (e.g., through facial recognition).

Some embodiments may be able to determine when a user is located within an area (e.g., within a retail establishment, within a section of a store, etc.). A mobile device (e.g., a wearable device, a smartphone, etc.) associated with the consumer may receive an indication of information to be tracked by a venue.

In some embodiments, a user interface (UI) may be provided using the mobile device that allows a consumer to opt in or out of participating in such information tracking. The UI may present a list of information types to be tracked and a set of associated control elements that allow the consumer to select the types of information allowed to be tracked. In this way, a consumer may opt in or opt out of distribution and/or use of the various types of information.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The features of the disclosure are set forth in the appended claims. However, for purpose of explanation, several embodiments are illustrated in the following drawings.

FIG. 1 illustrates an exemplary user interface (UI) of some embodiments that provides a way for users to select data for distribution and/or collection;

FIG. 2 illustrates a second exemplary UI of some embodiments that provides a way for users to select data for distribution and/or collection;

FIG. 3 illustrates a third exemplary UI of some embodiments that provides a way for users to select data for distribution and/or collection;

FIG. 4 illustrates a schematic block diagram of an exemplary hardware system used by some embodiments;

FIG. 5 illustrates a schematic block diagram of an exemplary software system of some embodiments;

FIG. 6 illustrates a schematic block diagram showing detailed views of some exemplary components of the software system of FIG. 5;

FIG. 7 illustrates a flow chart of an exemplary client-side process of some embodiments that manages distribution and collection of tracked data;

FIG. 8 illustrates a flow chart of an exemplary server-side process of some embodiments that manages distribution and collection of tracked data;

FIG. 9 illustrates a flow chart of an exemplary client-side process of some embodiments that manages distribution and collection of tracked data associated with a venue;

FIG. 10 illustrates a flow chart of an exemplary client-side process of some embodiments that provides tracked data to a user;

FIG. 11 illustrates a flow chart of an exemplary server-side process of some embodiments that provides tracked data to a user;

FIG. 12 illustrates a flow chart of an exemplary client-side process of some embodiments that provides tracked data to and receives tracking updates from an administrator associated with a venue;

FIG. 13 illustrates a flow chart of an exemplary server-side process of some embodiments that provides tracked data to and receives tracking updates from an administrator associated with a venue; and

FIG. 14 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various inventive features are described below that can each be used independently of one another or in combination with other features. Broadly, some embodiments generally provide ways to control the information that is collected by various entities. The information may include, for example, location, transaction information, and identity.

Such information may be tracked by a venue such as, for example, a retail establishment, an office, office building, school, public space, an attraction, mall, theme park, etc. In addition, some venues may be divided into sub-areas such as sections of a retail store, rides at a theme park, concession stands at a stadium, etc.

The venues (and/or sections thereof) may indicate information to be tracked. Some embodiments may select from the indicated information to prevent tracking of some or all of the indicated information.

Location is one example of a type of information that may be tracked. Location information may be determined when a user is present in a venue. Different tracking examples include Internet Protocol (IP) tracking (by reading and following the IP address and/or MAC address of a device), using a beacon system where a venue has different hotspots (e.g., various areas within a store) where devices transmit location information to such hotspots in real time, visual tracking, and/or other appropriate ways of tracking. The tracked location information may be used to determine, for example, which sections of a venue are popular with a consumer (e.g., the consumer may like computers, not care for clothes, etc.). Such information can then be used to target specific types of advertisements to the consumer while in the venue, through direct mail, and/or other appropriate ways of advertising.

A first exemplary embodiment provides a method that controls, at a user device, distribution and tracking of information. The method includes receiving, at the user device, a tracking notification, extracting, at the user device, a set of elements from the tracking notification, the set of elements including a set of information types, receiving, at the user device, a set of user selections from among the set of information types, and sending, from the user device, a response to the tracking notification, the response including the set of user selections.

A second exemplary embodiment provides a user device that controls distribution and tracking of information. The user device includes a processor for executing a set of instructions, and a non-transitory medium that stores the set of instructions. The set of instructions includes receiving, at the user device, a tracking notification, extracting, at the user device, a set of elements from the tracking notification, the set of elements including a set of information types, receives, at the user device, a set of user selections from among the set of information types, and sending, from the user device, a response to the tracking notification, the response including the set of user selections.

A third exemplary embodiment provides a method that controls, at a server, distribution and tracking of information. The method includes detecting, at the server, a consumer device within a defined area, retrieving, at the server, a set of tracking elements associated with the defined area, the set of tracking elements including a set of information types, sending, to the consumer device, a notification including the set of tracking elements, and receiving, from the consumer device, a response to the tracking notification, the response including a set of user selections from among the set of information types.

A fourth exemplary embodiment provides a server that controls distribution and tracking of information. The server includes a processor for executing a set of instructions and a non-transitory medium that stores the set of instructions. The set of instructions includes detecting, at the server, a consumer device within a defined area, retrieving, at the server, a set of tracking elements associated with the defined area, the set of tracking elements including a set of information types, sending, to the consumer device, a notification including the set of tracking elements, and receiving, from the consumer device, a response to the tracking notification, the response including a set of user selections from among the set of information types.

Several more detailed embodiments are described in the sections below. Section I provides a description of several exemplary UIs provided by some embodiments. Section II then describes exemplary system architectures of some embodiments. Next, Section III describes various methods of operation implemented by some embodiments. Lastly, Section IV describes an exemplary computer system which may implement some embodiments.

### I. User Interface

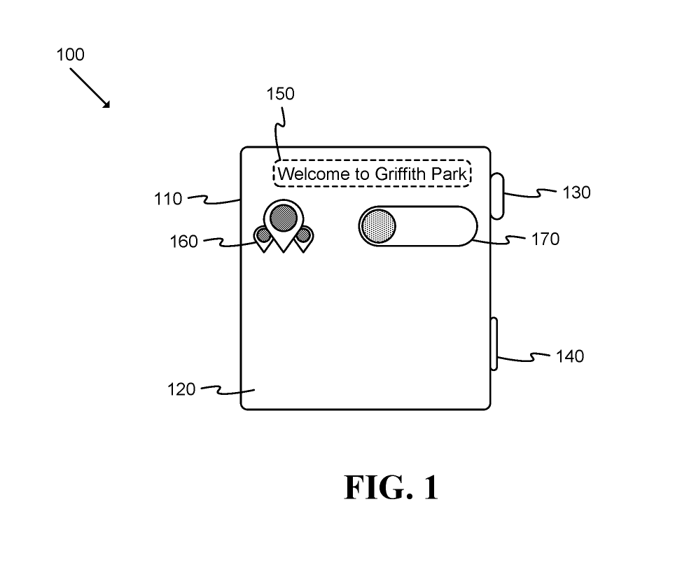

FIG. 1 illustrates an exemplary user interface (UI) 100 of some embodiments that provides a way for users to select data for distribution and/or collection. In this example, the UI may be provided using a user device 110. Such a device may be a wearable device (e.g., a watch, bracelet, etc.), a handheld device (e.g., a tablet, smartphone, etc.), and/or other appropriate device. The device may include UI hardware elements such as a display or touchscreen 120 (the screen spans the entire visible face of the device 110 in this example), various buttons 130, and/or other inputs 140 (e.g., rocker or slide switches, keypads, etc.). In addition, some embodiments may include various other inputs and/or outputs such as microphones, speakers, cameras or other visual sensors, motion detectors, haptic feedback elements, etc.

The UI 100, as displayed on screen 120 may include notification areas 150, information type identifiers 160, and/or tracking controllers 170. Such a UI may be displayed, for instance, when the device receives a notification or request for tracking information. In some cases, the UI may be launched when a user device enters a specific area (e.g., a location associated with a retail venue).

In this example, the single notification area 150 includes a message regarding a venue. Additional notification areas may be included. Each notification area may include elements such as text, graphics, animations, video, and/or other multimedia content capable of being presented by device 110.

The type identifier 160 in this example is an icon representing position or location tracking. Different embodiments may have different arrangements of type identifiers (e.g., differing number of identifiers, different representations, different sizes, etc.). The type identifier may include text, graphics, etc.

The tracking controller 170 may be, as in this example, a slider switch (e.g., with the slider moved to the left to disable tracking and moved to the right to enable tracking) or other appropriate element (e.g., a checkbox, button, etc.). In this example, the controller is in an “off”, “disabled”, or “non-allowed” position (or “state”) regarding tracking of location information.

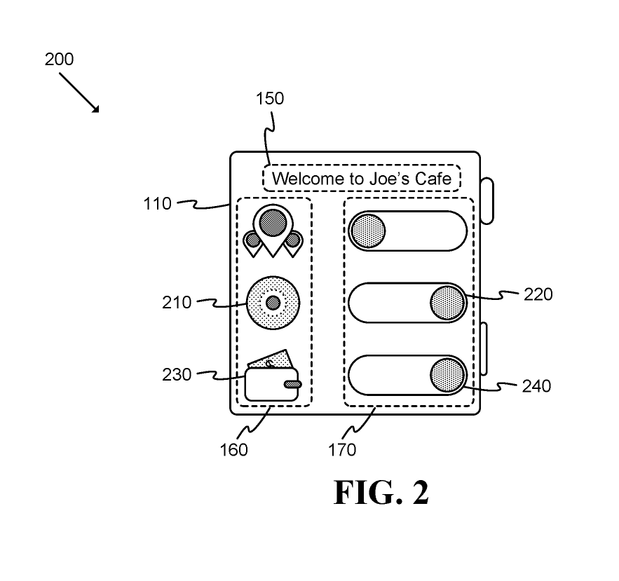

FIG. 2 illustrates a second exemplary UI 200 of some embodiments that provides a way for users to select data for distribution and/or collection. The UI may be presented using device 110 and may be invoked based on a received notification or other appropriate criteria.

In this example, the UI includes notification area 150, a set of identifier 160 and corresponding tracking controllers 170 described above. In addition, the UI includes an identifier 210 and controller 220 associated with facial recognition, and an identifier 230 and controller 240 associated with transaction information.

The controllers 170, 220, and 240 indicate that, in this example, location information tracking is disabled while facial recognition and transaction information tracking are enabled. The controllers may allow a user to select from various possible tracking scenarios, as desired.

In this example, actual location information may not be tracked based on the indications. However, the facial recognition or transaction tracking may associate the tracked information with a defined location (e.g., a store location, a town or neighborhood, etc.).

In addition to, or in place of, facial recognition, some embodiments may track information such as sign in (e.g., using a rewards card at a store), response to a query, and/or other relevant information that may associate the device 110 with a venue, location, transaction, event, etc.

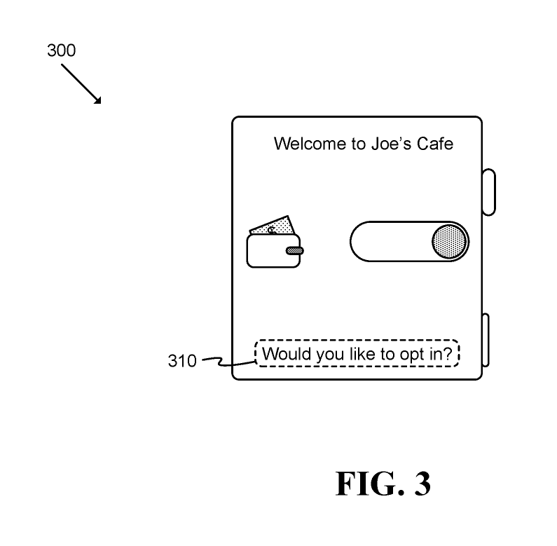

FIG. 3 illustrates a third exemplary UI 300 of some embodiments that provides a way for users to select data for distribution and/or collection. This example includes an additional notification area 310 that may provide additional information to a user regarding information tracking.

If a user allows such tracking (e.g., transaction tracking in this example), the information may be associated with a venue and include transaction information such as items and/or services purchased, price paid, date and time of purchase, etc. In addition, the information may include venue information such as location, venue type, etc. The information may also include attributes related to the venue such as name, type, status, etc. If multiple information types are enabled, the selected types may be associated when tracking. For instance, if transactions and location are tracked, an executed transaction may be associated with a location that is ascertained during the transaction.

The tracked information may allow a user to review a listing of items associated with a particular venue or location. The listing may include purchased items, viewed items (e.g., items that a user tags or otherwise indicates interest), etc. As another example, the tracked information may be used to determine a time spent in a venue or department and the listing may reflect such interest in various ways (e.g., time spent in a gardening section of a store, time spent at a car dealership, etc.). Such a listing may be presented in various appropriate ways (e.g., transactions sorted by time and date, locations sorted by time spent there, etc.).

One of ordinary skill in the art will recognize that the UIs and UI elements described above in reference to FIGS. 1-3 may be implemented in various different ways without departing from the scope of the disclosure. For instance, different embodiments may include additional elements, omit various elements, rearrange the elements, and/or otherwise change the presentation of the various elements. As another example, different embodiments may include different numbers and/or arrangements of buttons and/or other device elements (e.g., display or touchscreens, keypads, etc.). In addition, the various specific UI elements may be represented in various different ways (e.g., using different graphics or icons than shown, using text, etc.).

### II. System Architecture

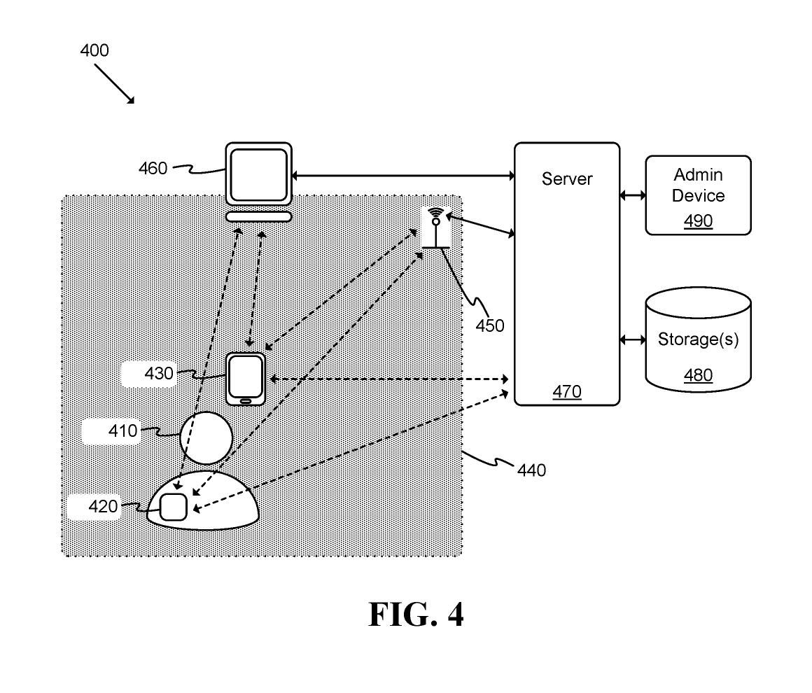

FIG. 4 illustrates a schematic block diagram of an exemplary hardware system 400 used by some embodiments. In this example, a user 410 is associated with a wearable device 420 and a mobile device 430. Area or location 440 may be defined in various appropriate ways and may include elements such as wireless beacons 450 and venue devices 460. In addition, the system may include a server 470 with associated storage 480 and/or admin device 490. The system may include multiple instances of each device type (and/or omit one or more device types).

The wearable device 420 may be similar to device 110. The device 420 may be able to wirelessly communicate with various other system elements. Such wireless communication may include direct links (e.g., Bluetooth, Wi-Fi, etc.), network connections (e.g., cellular networks, wireless networks, Ethernet, etc.), and/or other appropriate links (e.g., wired connections, radio communication, etc.).

The user device 430 may be a mobile device such as a smartphone or tablet. The user device 430 may be able to communicate with the various other system elements using similar pathways as the wearable device 420. In some cases, the wearable device and user device 430 may operate conjunctively. For instance, the user device may communicate with various other system elements and use the wearable device 420 as a canvas for user interaction. As another example, the wearable device 420 may relay various communications through the user device 430. For instance, the user device may have access to a cellular network and the wearable device 420 may not be able to communicate using such a network but may be able to communicate with the user device 430 via a Bluetooth link.

The beacon 450 may include a transmitter that is able to send a beacon signal that is perceptible within region 440. Such a beacon signal may be sent using various appropriate communication pathways (e.g., Bluetooth, Wi-Fi, etc.). The beacon signal may include information such as location, affiliation to a venue, notification of information tracking, etc. In some embodiments, in addition to transmitting a signal, the beacon 450 may also be able to receive (and/or respond to) communications from other system elements.

The venue device 460 may be any device associated with a venue that is able to interact with other system elements. Examples of such devices include point of sale stations (e.g., registers, credit card processors, etc.), advertising displays, computing devices, and cameras or other sensors (e.g., motion detectors). Such devices may include transmitting capability such that notifications or other appropriate information may be sent to the user devices 420 and 430. In addition, the devices 460 may be able to communicate with other system elements.

The server 470 may be a computing device that is able to communicate across one or more networks and access storage 480. The server 470 may be able to execute instructions and/or process data. Storage 480 may be able to receive, store, and/or supply instructions and/or data. The server 470 and storage 480 may include local elements (e.g., a computing device located at a venue and accessible over a local area network provided by the venue) and/or network or distributed elements (e.g., cloud-based storage or computing, remote computing devices accessible over the Internet, etc.).

The admin device 490 may be a computing device used by those associated with a venue (e.g., store owners or employees, technical support staff, etc.) to interact with the system 400.

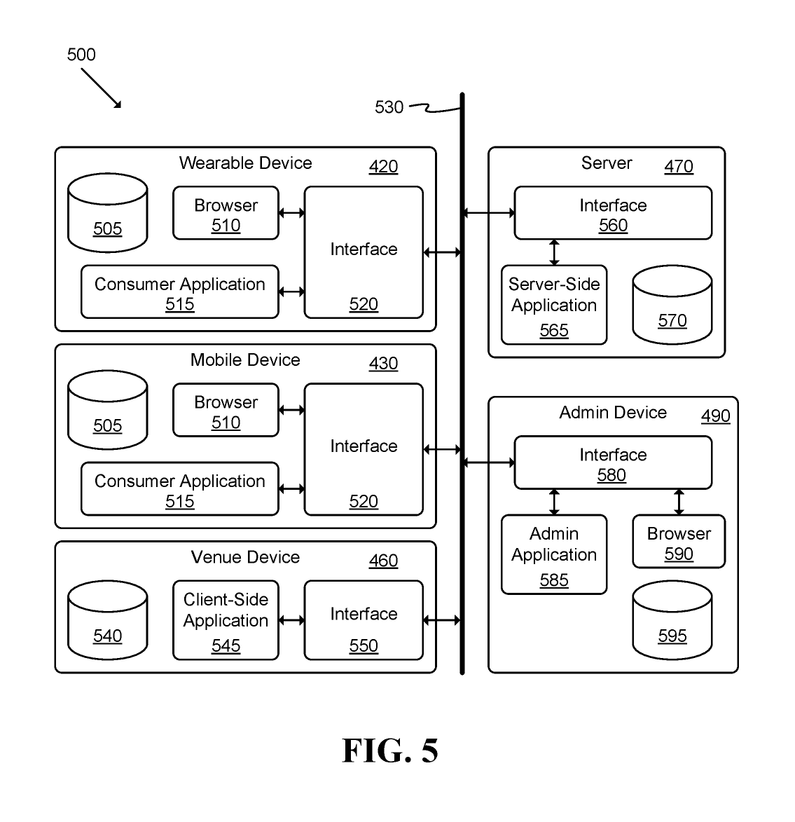

FIG. 5 illustrates a schematic block diagram of an exemplary software system 500 of some embodiments. Such a system may be implemented using hardware elements such as wearable device 420, mobile device 430, venue device 460, server 470, and/or admin device 490 described above. Although various elements may be described as being implemented using software, such elements may be implemented wholly or in part by electronic circuitry that is able to provide the various features described herein.

As shown, the wearable device 420 may include a storage 505, browser 510, consumer application 515, and an interface 520. The storage 505 may be able to store instructions and/or data for use by other device elements. The browser 510 (and/or other appropriate application) may allow the user to interact with other system elements, such as via a web-based interface. The consumer application 515 may generate various UI elements and/or act upon inputs received via the UI elements. The interface 520 may allow for communication across network 530.

The network 530 may include various pathways (e.g., wired connections, wireless connections, cellular connections, etc.), sub-networks, and/or interfaces to external networks (e.g., the Internet).

Mobile device 430 may include elements similar to those described above in reference to wearable device 420.

Venue device 460 may include a storage 540, client-side application 545, and interface 550. The storage 540 may be similar to storage 505 and the interface 550 may be similar to interface 520. The client-side application 545 may generate various UI elements and/or act upon inputs received via the UI elements. In addition, the client-side application 545 may automatically interact with other system elements (e.g., consumer application 515). For instance, a point of sale register may send a notification that purchase information will be tracked view the client-side application 545 and consumer application 515. The applications may further interact as a response is received (and/or otherwise automatically interact), if appropriate.

Server 470 may include an interface 560, a server-side application 565, and a storage 570. The storage 570 may be similar to storage 505 and the interface 560 may be similar to interface 520. The server-side application 565 may automatically interact with various other system elements, including the consumer application 515 and client-side application 545.

Admin device 490 may include and interface 580, and admin application 585, and browser 590, and storage 595. The storage 595 may be similar to storage 505, the browser 590 may be similar to browser 510, and the interface 560 may be similar to interface 520. The admin application 585 may interact with various other system elements, including the consumer application 515, client-side application 545, and the server-side application 585.

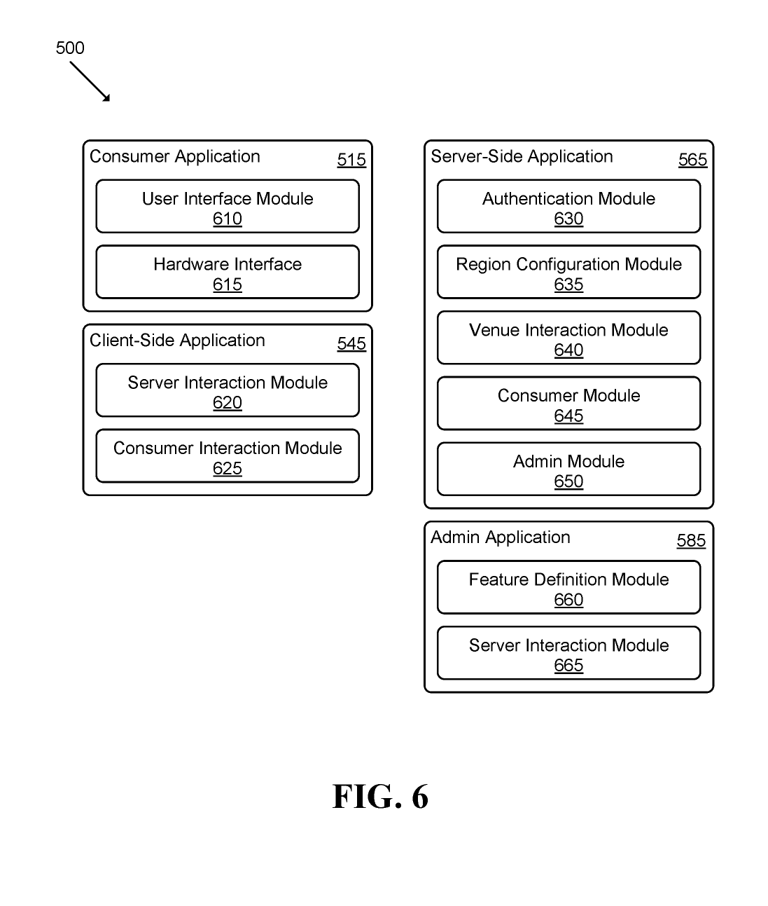

FIG. 6 illustrates a schematic block diagram showing detailed views of some exemplary components of software system 500.

As shown, the consumer application 515 may include a UI module 610 and a hardware interface 615. The UI module 610 may generate and/or interpret various UI elements. The UI module may be able to generate commands or messages that may be supplied to other system elements based on inputs received via the UI module. In addition, the UI module may generate and/or provide UI elements based on data received from other system elements. The hardware interface 615 may allow the application 515 to control or utilize elements of the user devices 420 and 430 (e.g., a touchscreen, storage, processor, etc.).

The client-side application 545 may include a server interaction module 620 and a consumer interaction module 625. The server interaction module 620 may be able to interact with the server-side application 565. The consumer interaction module 625 may be able to interact with the consumer application 515.

In some cases, the client-side application 545 may serve as a link between the consumer application 515 and the server-side application 565. For instance, the client-side application 545 may send a notification to the consumer application 515 when a user device is within a specified region and then interact with the consumer application to determine a set of tracking selections associated with the user device. The client-side application 545 may then send any collected information (e.g., location, transaction, etc.) to the server-side application 565.

The server-side application 565 may include an authentication module 630, a region configuration module 635, a venue interaction module 640, a consumer module 645, and an admin module 650. The authentication module 630 may verify user account information (e.g., username and password) and status (e.g., administrator privileges, consumer privileges, etc.). The region configuration module 635 may be able to receive location information, selection of venue devices and beacons, and/or other relevant region information (e.g., types of tracking information collected, notifications, etc.) and define various regions and associated tracking information.

The venue interaction module 640 may interact with venues via the client-side application 545 in some embodiments. The consumer module 645 may interact with the consumer application 515. The admin module 650 may interact with the admin application 585.

The admin application 585 may include a feature definition module 660 and a server interaction module 665. The feature definition module 660 may interact with the region configuration module 635 to define features associated with a region. The configuration module may receive selections of features (e.g., location tracking, facial recognition, transaction logging, etc.) and associated options, notifications, etc. to be presented to consumers. The server interaction module 665 may be able to interact with the admin module 650. The server interaction module 665 may relay administrator selections or settings to the server-side application 565. In some embodiments, the admin application 585 may be able to interact with the client-side application 545 in order to control, supply data to, and/or otherwise interact with various venue devices.

One of ordinary skill in the art will recognize that the systems of FIGS. 4-6 are exemplary and different embodiments may be implemented in various different ways without departing from the scope of the disclosure. For instance, some embodiments may include additional elements or omit some elements. As another example, different embodiments may combine or divide various elements.

### III. Methods of Operation

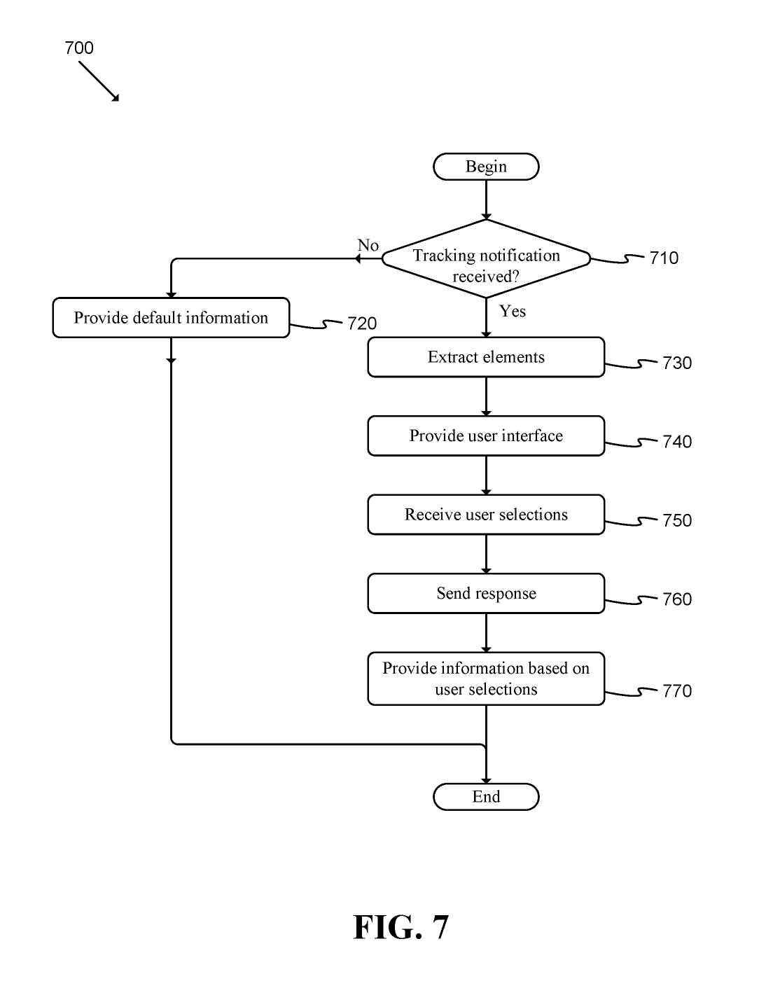

FIG. 7 illustrates a flow chart of an exemplary client-side process 700 of some embodiments that manages distribution and collection of tracked data. Such a process may be executed by an element such as wearable device 420 or mobile device 430. The process may begin, for instance, when a mobile device is powered on.

As shown, the process may determine (at 710) whether a tracking notification has been received. Such a notification may include, for example, a message received from a retailer device such as a register, display, PC, beacon, etc. The notification may include a listing of types of information to be tracked and/or other appropriate information (e.g., venue or section information, selections from a previous visit, etc.).

If the process determines (at 710) that no notification has been received, the process may provide (at 720) default information and then may end. Such default information may be provided based on various relevant factors (e.g., user selection, factory default settings, etc.).

If the process determines (at 710) that a notification has been received, the process may extract (at 730) elements included in the notification and provide (at 740) a UI based at least partly on the extracted elements. Such a UI may be similar to UIs 100-300 described above. The extracted elements may include, for instance, information types, previous selections, text, graphics, and/or other appropriate elements.

Next, the process may receive (at 750) a set of user selections. Such selections may be made, for example, using controllers such as controllers 170, 220 and 240.

The process may then send (at 760) a response to the notification, as appropriate. In some cases, the response may be provided to the element that provided the notification. For instance, in a retail establishment a user device may receive a list of information types to be tracked from a local server associated with the retail establishment. The user selections may then be provided to the local server in a response message. As another example, in a retail establishment a user device may receive the information from a beacon that is able to transmit but not receive. In such a case, the response may be sent to another device (e.g., a local server or remote server). Such a device may be identified by information included in the notification and/or other appropriate ways. In some cases, no response may be sent (e.g., when any tracked information is controlled by the user device).

Next, the process may provide (at 770) information based on the user selections and then may end. For instance, the user may elect to share location information (as determined by the mobile device) and provide only that information to the notifying resource.

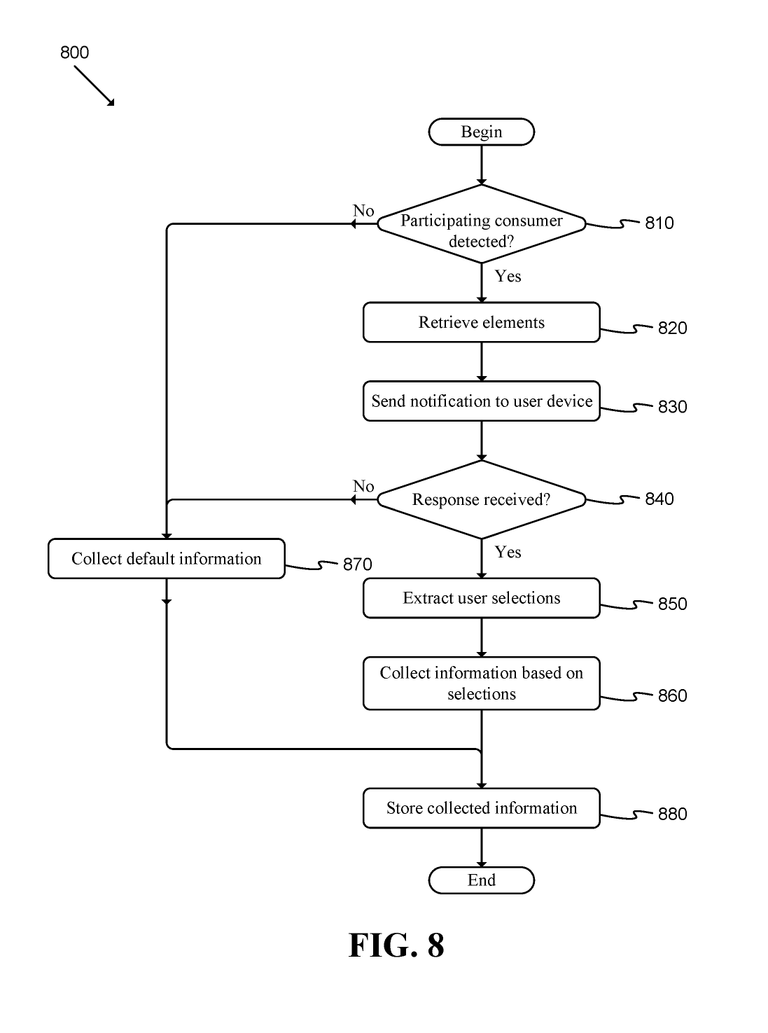

FIG. 8 illustrates a flow chart of an exemplary server-side process 800 of some embodiments that manages distribution and collection of tracked data. Such a process may be a complement to process 700. Such a process may be executed by an element such as server 470. The process may begin, for instance, when a server is powered on.

As shown, process 800 may determine (at 810) whether a participating consumer has been detected. Such a determination may be made in various appropriate ways (e.g., motion detection, visual detection, detecting a response to a query, etc.). In some cases, the detection may be performed by a local element (e.g., a venue device such as a beacon, display, etc.). The local elements may then send a detection message to the server.

Next, the process may retrieve (at 820) a set of elements. Such elements may include, for instance, types of information to be tracked, notification information (e.g., text, graphics, etc.), and/or other appropriate elements associated with a venue, user, etc.

The process may then send (at 830) a notification to the user device based at least partly on the retrieved elements. In some embodiments, the notification may be provided as a beacon signal or other signal that is not directed toward a specific user device but may be received by user devices within a transmitting range. In addition, the notification may be sent without requiring detection of a user device (e.g., a beacon signal may be transmitted continuously, at regular intervals, etc.).

Next, the process may determine (at 840) whether a response has been received. If the process determines (at 840) that a response has been received, the process may extract (at 850) the user selections and collect (at 860) information based on the selections. In some cases, such information may be collected by one or more local devices (e.g., beacons, point-of-sale devices, etc.) and sent to the server. The server may send commands or messages to the local devices indicating the information to be collected (e.g., location information is to be discarded or not collected while purchase information is to be collected).

If the process determines (at 840) that no response has been received, the process may collect (at 870) default information. In some cases, no information may be collected if a response is not received. The information may be collected (at 860 or 870) from various appropriate resources (e.g., a user device, venue device(s), local server, etc.).

After collecting (at 860 or 870) the information, the process may store (at 880) the collected information and then may end. In some embodiments, the collected information may be sent to other entities. For instance, collected information may be sent to a venue device or local server.

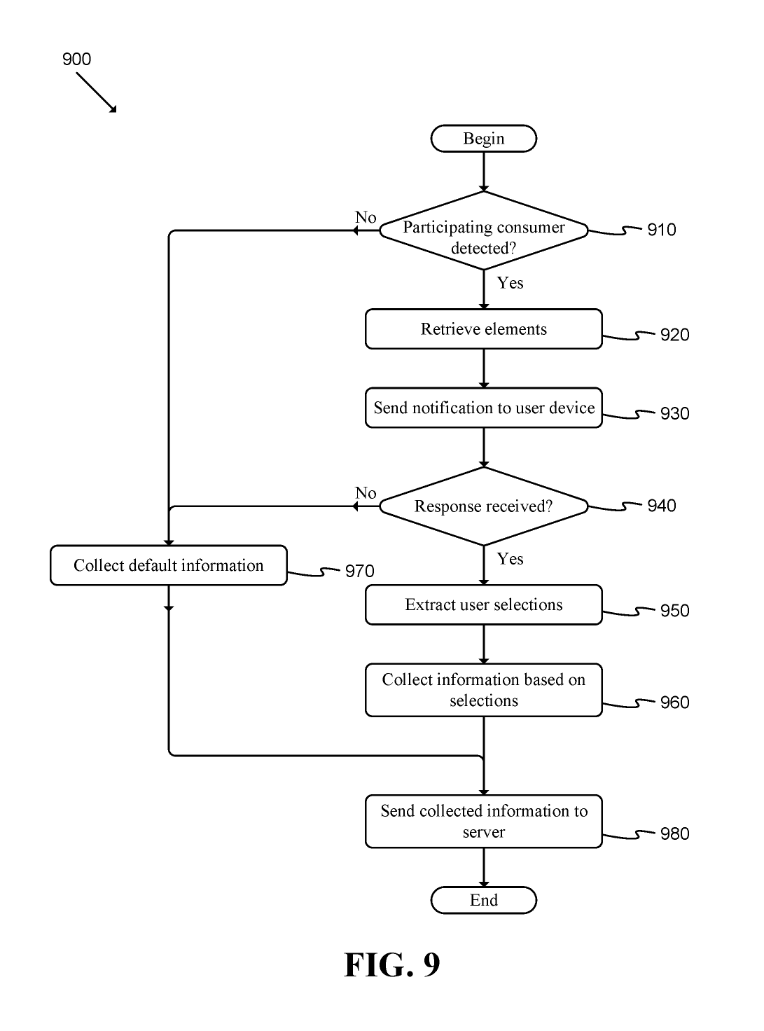

FIG. 9 illustrates a flow chart of an exemplary client-side process 900 of some embodiments that manages distribution and collection of tracked data associated with a venue. Such a process may be a complement to process 700 and/or process 800. Such a process may be executed by an element such as beacon 450 or venue device 460. The process may begin, for instance, when a venue device is powered on.

Operations 910-970 may be similar to operations 810-870 described above. As shown, after collecting (at 960 or 970) information, the process may send (at 980) the collected information to a server and then may end.

In some embodiments, processes 800 and 900 may be jointly executed by a local device and a remote server. For instance, a local device such as a beacon may transmit a signal that is received by a user device. The user device may, in turn, provide information to be tracked to a local or remote server (e.g., when a beacon is not able to receive data). As another example, a local server may receive a set of user selections and at least partly control the operation of other system elements based on the selections (e.g., when a user opts-out of tracking transaction information, the local server may not transmit purchase information to a remote server).

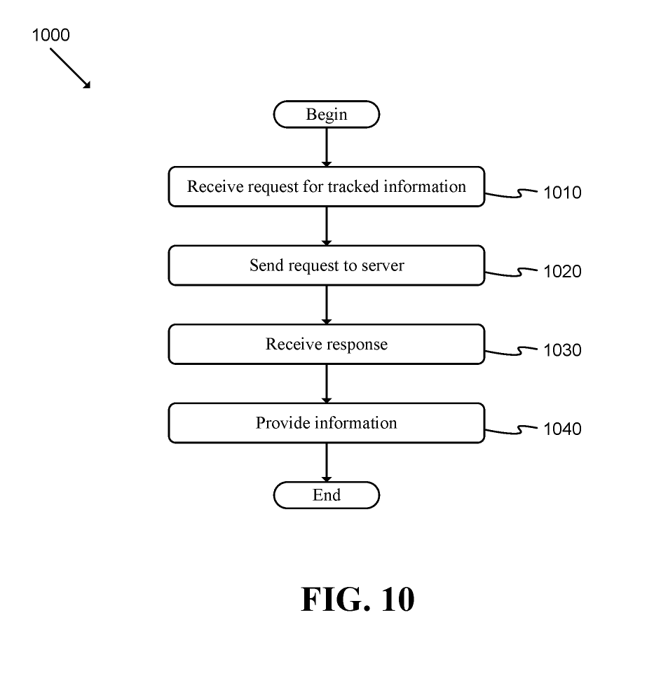

FIG. 10 illustrates a flow chart of an exemplary client-side process 1000 of some embodiments that provides tracked data to a user. Such a process may be executed by an element such as wearable device 420 or mobile device 430. The process may begin, for instance, when a client application is launched or when a web-based interface is accessed.

As shown, the process may receive (at 1010) a request for tracked information. Such a request may be received via an appropriate UI that allows a consumer to select from tracked information based on various relevant criteria (e.g., date, location, etc.). For instance, a user may wish to review all tracked purchases within the last month.

Next, the process may send (at 1020) a request to a server. The request may include information that identifies the tracked information received at 1010.

The process may then receive (at 1030) a response to the request, provide (at 1040) the requested information and then may end.

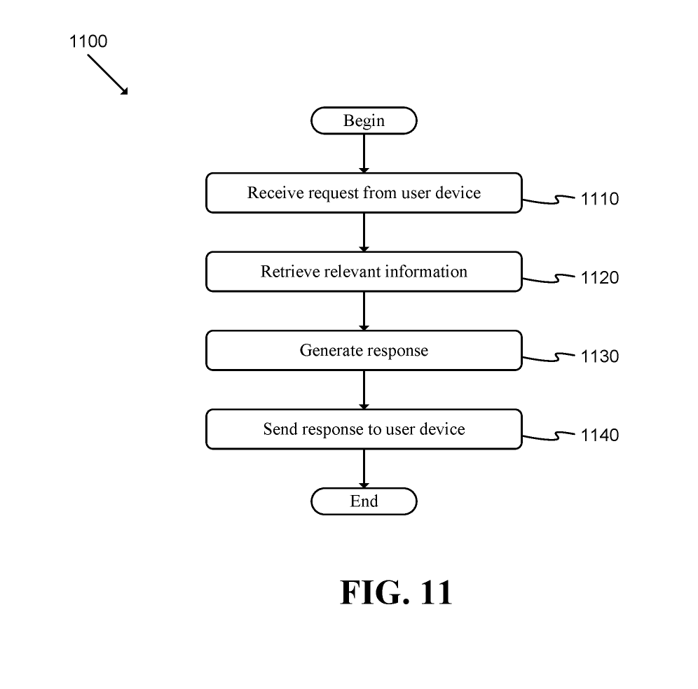

FIG. 11 illustrates a flow chart of an exemplary server-side process 1100 of some embodiments that provides tracked data to a user. Such a process may be a complement to process 1000. Such a process may be executed by an element such as server 470. The process may begin, for instance, when a server is powered on.

As shown, the process may receive (at 1110) a request from a user device. Next, the process may retrieve (at 1120) relevant information based at least partly on the request.

Next, the process may generate (at 1130) a response based at least partly on the retrieved information. The process may then send (at 1140) the response to the user device and then may end.

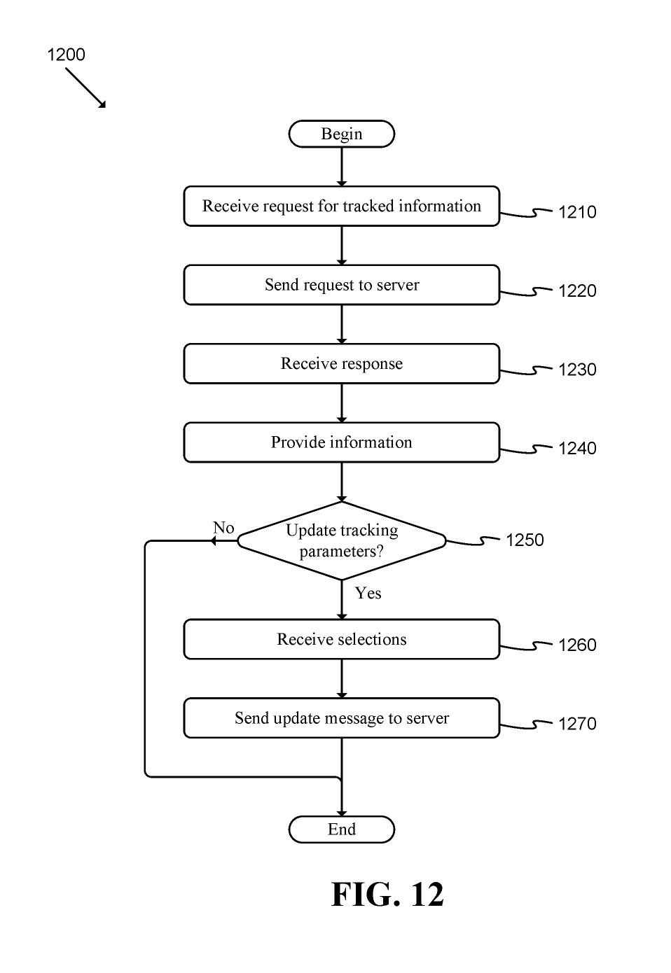

FIG. 12 illustrates a flow chart of an exemplary client-side process 1200 of some embodiments that provides tracked data to and receives tracking updates from an administrator associated with a venue. Such a process may be executed by an element such as beacon 450 or venue device 460. The process may begin, for instance, when a client application is launched or when a web-based interface is accessed.

Operations 1210-1240 may be similar to operations 1010-1040 described above. Rather than a consumer-user, as in process 1000, process 1200 may be associated with a venue administrator (e.g., a store employee or manager).

After providing (at 1240) any requested information, the process may determine (at 1250) whether to update tracking parameters. Such a determination may be made based on various relevant factors, such as selections made by the administrator-user. If the process determines (at 1250) that there are no updates, the process may end.

If the process determines (at 1250) that there are updates, the process may receive (at 1260) the selections, send (at 1270) an update message to the server, and then may end. In some embodiments, the updates may be distributed to local devices (e.g., venue devices) in addition to or in place of the server.

The updates may include updates to information tracking type such as when a venue installs a visual detection system, when a new retail section is deployed, etc.

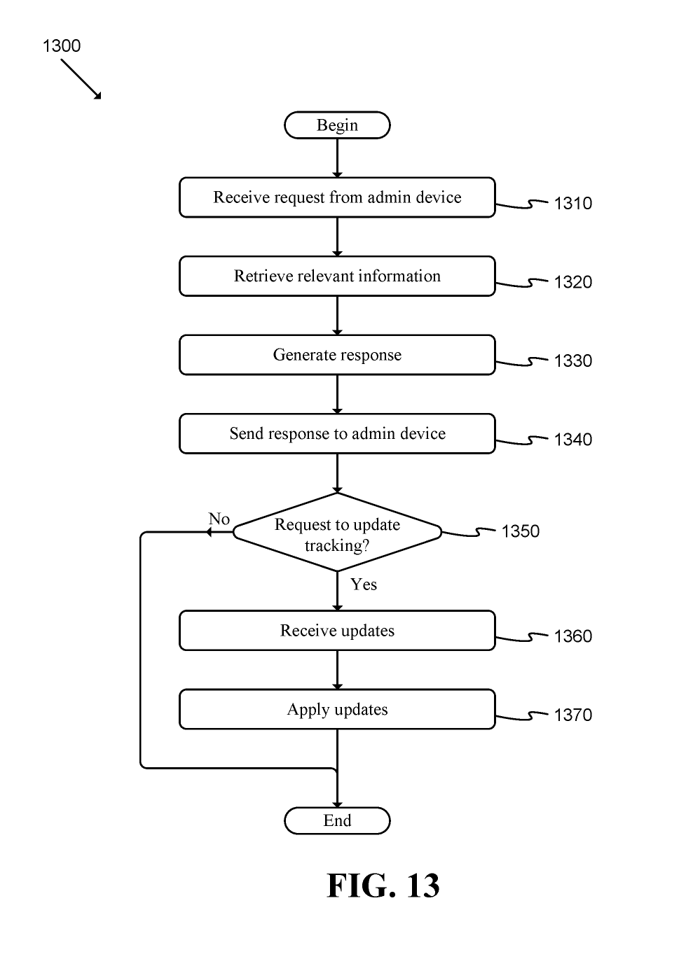

FIG. 13 illustrates a flow chart of an exemplary server-side process 1300 of some embodiments that provides tracked data to and receives tracking updates from an administrator associated with a venue. Such a process may be a complement to process 1200. Such a process may be executed by an element such as server 470. The process may begin, for instance, when a server is powered on.

Operations 1310-1340 may be similar to operations 1110-1140 described above. Rather than a consumer-user, as in process 1100, process 1300 may be associated with a venue administrator (e.g., a store employee or manager).

After sending (at 1340) a response, the process may determine (at 1350) whether a request to update tracking information was received. If the process determines (at 1350) that no response was received, the process may end.

If the process determines (at 1350) that a request was received, the process may receive (at 1360) and apply (at 1370) the updates and then may end. The updates may be applied in various appropriate ways. For instance, updates may be received from a regional administrator and then distributed to all devices (e.g., venue devices, local servers, etc.) associated with stores in that region.

One of ordinary skill in the art will recognize that the example processes described above in reference to FIGS. 7-13 may be implemented in various different ways without departing from the scope of the disclosure. For instance, different embodiments may perform the operations in different orders than described. As another example, some embodiments may include additional operations and/or omit various listed operations. Each process may be divided into multiple sub-processes and/or combined with other processes to form macro processes. In addition, sub-sets of operations may be performed iteratively based on various appropriate criteria (e.g., multiple messages may be sent back and forth among various system resources during a conversation).

### IV. Computer System

Many of the processes and modules described above may be implemented as software processes that are specified as one or more sets of instructions recorded on a non-transitory, tangible storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

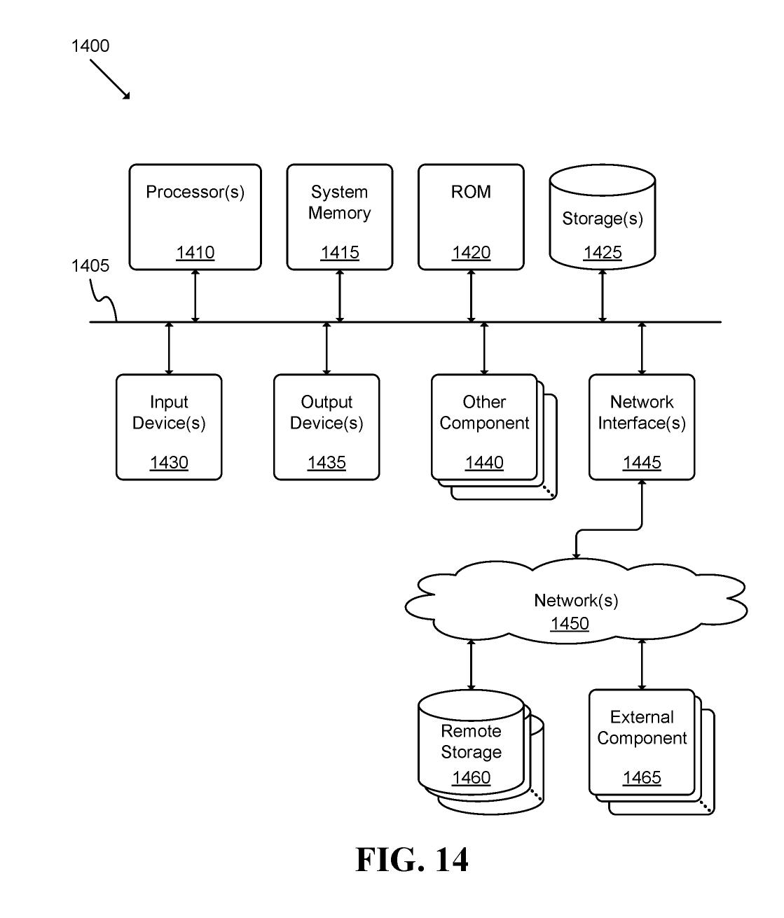

FIG. 14 illustrates a schematic block diagram of an exemplary computer system 1400 used to implement some embodiments. For example, the system described above in reference to FIGS. 1-6 may be at least partially implemented using computer system 1400. As another example, the processes described in reference to FIGS. 7-13 may be at least partially implemented using sets of instructions that are executed using computer system 1400.

Computer system 1400 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1400 may include at least one communication bus 1405, one or more processors 1410, a system memory 1415, a read-only memory (ROM) 1420, permanent storage devices 1425, input devices 1430, output devices 1435, various other components 1440 (e.g., a graphics processing unit), and one or more network interfaces 1445.

Bus 1405 represents all communication pathways among the elements of computer system 1400. Such pathways may include wired, wireless, optical, and/or other appropriate communication pathways. For example, input devices 1430 and/or output devices 1435 may be coupled to the system 1400 using a wireless connection protocol or system.

The processor 1410 may, in order to execute the processes of some embodiments, retrieve instructions to execute and/or data to process from components such as system memory 1415, ROM 1420, and permanent storage device 1425. Such instructions and data may be passed over bus 1405.

System memory 1415 may be a volatile read-and-write memory, such as a random access memory (RAM). The system memory may store some of the instructions and data that the processor uses at runtime. The sets of instructions and/or data used to implement some embodiments may be stored in the system memory 1415, the permanent storage device 1425, and/or the read-only memory 1420. ROM 1420 may store static data and instructions that may be used by processor 1410 and/or other elements of the computer system.

Permanent storage device 1425 may be a read-and-write memory device. The permanent storage device may be a non-volatile memory unit that stores instructions and data even when computer system 1400 is off or unpowered. Computer system 1400 may use a removable storage device and/or a remote storage device as the permanent storage device.

Input devices 1430 may enable a user to communicate information to the computer system and/or manipulate various operations of the system. The input devices may include keyboards, cursor control devices, audio input devices and/or video input devices. Output devices 1435 may include printers, displays, and/or audio devices. Some or all of the input and/or output devices may be wirelessly or optically connected to the computer system.

Other components 1440 may perform various other functions. These functions may include performing specific functions (e.g., graphics processing, sound processing, etc.), providing storage, interfacing with external systems or components, etc.

Finally, as shown in FIG. 14, computer system 1400 may be coupled to one or more networks 1450 through one or more network interfaces 1445. For example, computer system 1400 may be coupled to a web server on the Internet such that a web browser executing on computer system 1400 may interact with the web server as a user interacts with an interface that operates in the web browser. Computer system 1400 may be able to access one or more remote storages 1460 and one or more external components 1465 through the network interface 1445 and network 1450. The network interface(s) 1445 may include one or more application programming interfaces (APIs) that may allow the computer system 1400 to access remote systems and/or storages and also may allow remote systems and/or storages to access computer system 1400 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method comprising:
extracting, at the user device, a set of elements from a tracking notification, the set of elements comprising a set of information types;
providing a user interface (UI) that includes an indicator relating to information types
receiving a set of user selections from among the plurality of information types; and
determining the state of each of said tracking controllers;
sending a response to the tracking notification having user selected information types based on said tracking controllers.

2. (canceled)

3. The method of claim 1, wherein the indicator comprises a graphical icon and the tracking controller comprises a slider switch.

4. The method of claim 1, wherein the tracking notification is received from one of a venue device and a server and the response is sent to one of the venue device and the server.

5. The method of claim 1, wherein the set of information types comprises at least one of location, visual recognition, and transaction information.

6. A user device comprising:
a processor for executing a set of instructions; and
a non-transitory storage medium that stores the set of instructions, wherein the set of instructions comprises:
receiving a tracking notification;
extracting a set of elements from the tracking notification having a set of information types;
receiving a set of user selections from among the set of information types; and
sending, from the user device, a response to the tracking notification, the response comprising the set of user selections.

7. The user device of claim 6, wherein the set of instructions that receive the set of user selections further comprises:
providing an indicator for each information type in the set of information types;
providing a set of tracking controllers, each tracking controller associated with a particular information type; and
determining a state of each tracking controller.

8. The user device of claim 7, wherein the indicator comprises a graphical icon and the tracking controller comprises a slider switch.

9. The user device of claim 6, wherein the tracking notification is received from one of a venue device and a server and the response is sent to one of the venue device and the server.

10. The user device of claim 6, wherein the set of information types comprises at least one of location, visual recognition, and transaction information.

11-15. (canceled)

16. A server comprising:
a processor for executing a set of instructions; and
a non-transitory storage medium that stores the set of instructions, wherein the set of instructions comprises:
detecting a consumer device within a defined area;
retrieving, at the server, a set of tracking elements associated with the defined area, the set of tracking elements comprising a set of information types;
sending, to the consumer device, a notification comprising the set of tracking elements; and
receiving, from the consumer device, a response to the tracking notification,
the response comprising a set of user selections from among the set of information types.

17. The server of claim 16, wherein the set of instruction further comprises:
collecting information based on the set of user selections; and storing the collected information.

18. The server of claim 16, wherein the set of instructions that detect the consumer device comprises receiving a notification from a venue device associated with the defined area.

19. The server of claim 16, wherein the set of instructions further sends, to a venue device associated with the defined area, a message indicating the set of user selections.

20. The server of claim 16, wherein the set of information types comprises at least one of location, visual recognition, and transaction information.
